(19) United States
(12) Patent Application Publication
(10) Pub. No.: US 2007/0197207 A1
(43) Pub. Date: Aug. 23, 2007

(54) Machine for improving Cellular Coverage and process for making the installation of the machine easy for a consumer for optimum performance

(76) Inventors: Robert James Carstens, Santa Rosa, CA (US); Heung-Sik Park, Seoul (KR); June-Sue Lee, Seoul (KR)

Correspondence Address: Robert James Carstens, 1985 W. Bristlecone Ct., Santa Rosa, CA, 95403, US

(21) Appl. No.: 11/479,278

(22) Filed: Jun. 30, 2006

Related U.S. Application Data
(60) Provisional application No. 60/776,412, filed on Feb. 23, 2006.

(51) Int. Cl. H04Q 7/20

(52) U.S. Cl. 455/423

(57) ABSTRACT

A machine and method for improving Cellular Coverage in poor coverage areas with special Circuitry and consumer feedback mechanisms that specifically improves the installation process to insure the best possible system performance, with Circuitry that mathematically analyzes and a feedback mechanism informing the consumer of the signal level from the Carrier's Base Station into the Cellular Signal Booster which the consumer can use aiding them in tuning the direction of the antenna, and circuitry that mathematically analyzes and a feedback mechanism informing the consumer the radiated feedback path loss between the antenna that links to the Carrier's Base station and the antenna that links to the consumers Cellular Telephone Handset and the resultant amplification level of the signals, which the consumer can use aiding them to tune the location of the antenna that links to the consumers Cellular Telephone Handset for the best possible system performance.

### CROSS REFERENCE TO RELATED APPLICATIONS

This application is based on provisional application No. 60/776,412, filed Feb. 23, 2006, titled: “A machine for improving Cellular Coverage and process for making the installation of the machine easy for a consumer for optimum performance”, incorporated herein by reference.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of Wireless Telephony and more specifically to a machine for improving Cellular Coverage and process for making the installation of the machine easy for a consumer for optimum performance.

Ever since Cellular Telephones were first commercialized in 1983, there have always been problems with coverage in certain locations. Often signals from the Cellular Base Stations cannot reach Cellular Telephones Handsets. These holes in coverage result in dropped and intermittent phone calls, or no service. Though there are additional Cellular Base Stations being deployed to eliminate these coverage issues, there are still many circumstances that cannot be overcome by adding more Cellular Base Stations. Homes, buildings, automobiles, and underground locations are particularly problematic because the materials they are made of, such as wood, cement, metal, and earth, are not transparent to Cellular Electromagnetic Waves (RF). This resulting in the signals not reaching the Cellular Telephone Handsets.

To overcome this coverage issue, Cellular Signal Boosters, sometimes called Repeaters were invented to pickup the weak Cellular RF Signals, amplify them and reradiate them into the area where there are coverage problems. These Cellular Signal Boosters amplify both the RF signals from the Base station and the RF signals from the Cellular Handset. The Cellular Signal Boosters have two antennas, one to link to the Cellular Base Station and one to link with the Cellular Handset.

To insure no oscillations and optimum performance, Cellular Signal Boosters were installed by professional technicians that used expensive on site test equipment to install the Cellular Signal Boosters. When these consumers moved, they took the Cellular Signal Boosters with them to their new home and reinstalled the Cellular Signal Boosters themselves. Because of the lack of installation guidance to the consumer and no test equipment, oscillations were common, resulting in many Cellular outages. Cellular System Operators demanded that the manufacturer of Cellular Signal Boosters develop a new design to guarantee oscillations would not occur regardless of poor installations. Manufactures of Cellular Signal Boosters designed internal circuitry in the amplifiers to automatically reduce the system amplification level when the antennas were too close to each other to reduce feedback or completely shut down the Cellular Signal Boosters when oscillations were detected.

If the Cellular Signal Booster's system was shut down, typically an alarm light would come on telling the consumer that the system was shut down and needed changes in the installation of the antennas. This was the only indication in prior Cellular Signal Boosters to the user that there was a problem. Prior Cellular Signal Boosters depended on written instructions to emphasize to the consumer to keep the two antennas far apart from each other. Omni-directional antennas were also deployed for the antenna that links to the Carrier's Base Station so the consumer would not need to know the location of the base station. The use of these omni-directional antennas also reduced optimization, fine-tuning of the signals linking to the Cellular Base Station, increased the likelihood of oscillation, and caused issues with other unwanted RF signals interfering with the desired signals. The installation of the antenna that links to the consumers Cellular Telephone Handset also had no means to insure good performance. If the Cellular Signal Boosters system indicated too much feedback, which causes oscillation, the Cellular Signal Boosters amplifiers automatically reduced their amplification level to prevent oscillation. The resultant signal transmitted out of each antenna was reduced resulting in poor performance. The performance could be so poor, without the consumer being aware of a problem, that the Cellular Signal Boosters will not remove the Cellular System weak signal area, resulting in an unhappy consumer customer.

### BRIEF SUMMARY OF THE INVENTION

The primary object of the invention is to provide a Cellular Signal Booster that can be installed by a non-technical consumer for optimum performance.

Another object of the invention is to provide a Cellular Signal Booster that includes a feedback mechanism to the consumer by way of any of their senses such as a visual display or audible signal that informs the consumer of the signal level of the Carrier's Base Station into their Cellular Signal Booster.

Another object of the invention is to provide a Cellular Signal Booster that includes a feedback mechanism to the consumer by way of any of their senses such as a visual display or audible signal that guides the consumer to install the antenna that links to the Carrier's Base Station in a location to provide the best possible linking signals with the Base Station.

A further object of the invention is to provide a Cellular Signal Booster that a feedback mechanism to the consumer by way of any of their senses such as a visual display or audible signal that tells the consumer the signal level transmitted out of their Cellular Signal Booster.

Yet another object of the invention is to provide a Cellular Signal Booster that includes a feedback mechanism to the consumer by way of any of their senses such as a visual display or audible signal that guides the consumer to install the Antenna that links to the Cellular Telephone Handset in an optimum location for maximum performance and reduce oscillation probability.

Still yet another object of the invention is to provide a Cellular Signal Booster that incorporates the invention that continuously monitors the quality of system performance and provides a feedback mechanism to the consumer by way of any of their senses such as a visual display or audible signal insuring the installation remains stable over time.

Other objects and advantages of the present invention will become apparent from the following descriptions, taken in connection with the accompanying drawings, wherein, by way of illustration and example, an embodiment of the present invention is disclosed. In accordance with a preferred embodiment of the invention, there is disclosed a machine for improving Cellular Coverage comprising: Circuitry that mathematically analyzes the input signal level from the Carrier's Base Station into the Cellular Signal Booster, circuitry that mathematically analyzes the radiated feedback path loss between the antenna that links to the Carrier's Base Station and the Antenna that links to the consumers Cellular Telephone Handset, control circuitry that drives a feedback mechanism to the consumer by way of any of their senses such as a visual display or audible signal informing the consumer of the signal strength of the Carrier's Base Station into their Cellular Signal Booster, control circuitry that drives a feedback mechanism to the consumer by way of any of their senses such as a visual display or audible signal informing the consumer of the signal level transmitted out of the Cellular Signal Booster, a feedback mechanism to the consumer by way of any of their senses such as a visual display or audible signal informing the consumer of the input signal level from the Carrier's Base Station into the Cellular Signal Booster, and a feedback mechanism to the consumer by way of any of their senses such as a visual display or audible signal informing the consumer of the signal level transmitted out of the Cellular Signal Booster.

In accordance with a preferred embodiment of the invention, there is disclosed a process for improving Cellular Coverage comprising the steps of: improving the installation of the cellular Signal Booster System using the feedback mechanism to the consumer by way of any of their senses such as a visual display or audible signal to aid the consumer, and a process for optimization of the installation and location of the Antenna that links to the Carrier's Base station as well as a process for optimization of installation and location of the Antenna that links the consumer's Cellular Telephone Handset.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a schematic block diagram illustrating the basic operation of a Cellular Signal Booster.

FIG. 2 is a schematic block diagram illustrating the Cellular Signal Booster showing a feedback oscillation path.

FIG. 3 is a schematic block diagram illustrating the Cellular Signal Booster showing another feedback oscillation path.

FIG. 4 is a schematic diagram illustrating showing additional circuitry typically used to prevent oscillations of Cellular Signal Boosters.

FIG. 5 is a schematic diagram illustrating the Cellular Signal Booster with the invention included.

### Detailed Description of the Preferred Embodiments

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

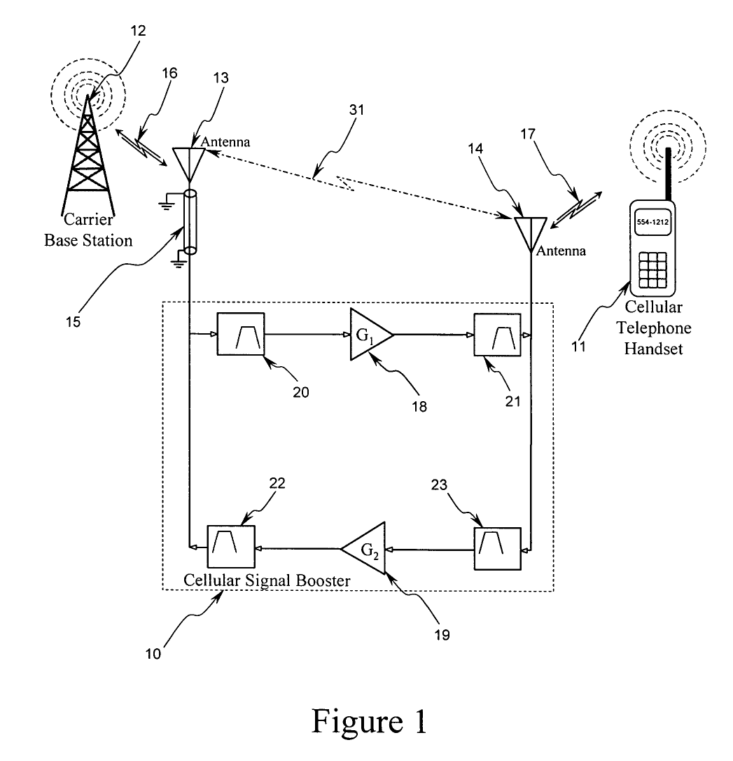

Turning first to the drawings in FIG. 1, shown is a block diagram of a machine commonly know as a Cellular Signal Booster (10) and its interface with the Carrier Base Station (12) and the consumer's Cellular Telephone Handset (11). The Cellular Signal Boosters is typically comprised of a mechanical box that houses the electronic circuits and two antennas, one Antenna (13) to link to the Carrier Base Station (12) through Electromagnetic Waves at Radio Frequencies (RF) (16), and one Antenna (14) to link to the consumer's Cellular Telephone Handset (11) through Electromagnetic Waves at Radio Frequencies (RF) (17). The Antenna that link to the Carrier Base Station (13) usually has a long Coax (15) to connect to the Cellular Signal Booster (10) so it can be installed in a stronger signal area to link with the Carrier Base Station (12).

The Cellular Signal Booster (10) circuitry consists of two amplifiers, one Amplifier (18) to amplify the signal from the Carrier Base Station and one Amplifier (19) to amplify the Cellular Telephone Handset (11) signal. The Filters (20) and (21) are tuned to the Carrier Base Station transmitted signal frequency to insure this signal routed through Amplifier G1 (18) and to the Antenna (14) and is rejected by the Filters (22) and (23). Moreover, The Filters (22) and (23) are tuned to the Cellular Telephone Handset transmitted signal frequency to insure this signal is routed through Amplifier G2 (19) and to the Antenna (13) and is rejected by the Filters (20) and (21). The result of these Filters and Amplifier routings of signals is a boost in level of the signal from the Carrier Base Station to the Cellular Telephone Handset and a boost in level of the signal from the Cellular Telephone Handset to the Carrier Base Station improving the Cellular call performance. These Filters (20), (21), (22), and (23) also prevent an electrical conducted oscillation path between the two Amplifiers (18) and (19).

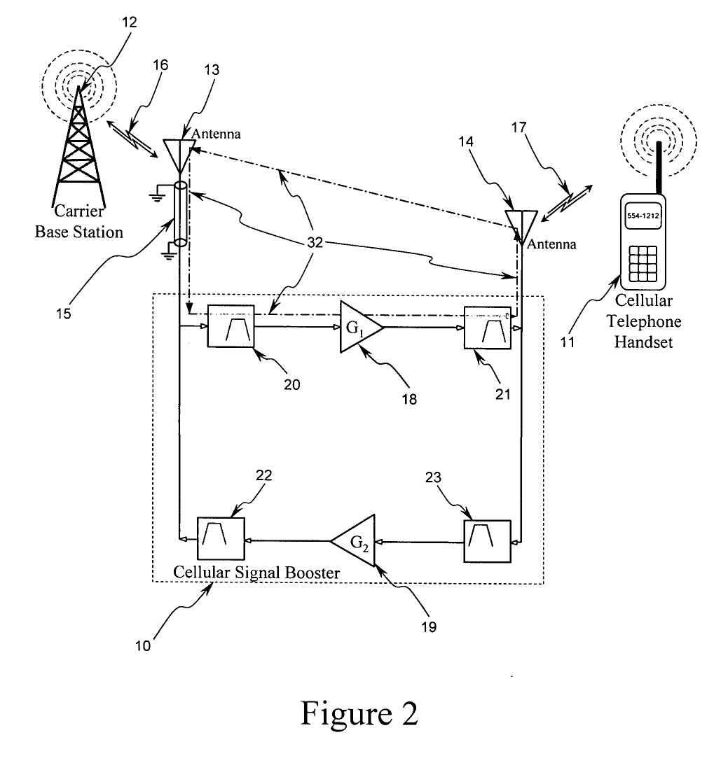

Turning to the drawings in FIG. 2, showing the same drawing as in FIG. 1 but with a signal path (32) highlighted. As a consequence of the individual Amplifier's inputs and outputs being tuned to the same frequency through their respective filters the Cellular Signal Boosters can go into to an unstable mode and oscillate. The oscillation is caused by an RF radiated feedback path between the two antennas (13) and (14). The complete feedback path is indicated by the dashed line (32). The output Amplifier G1 (18) who's output goes through Filter (21) then through the Antenna (14) then radiates through free air to Antenna (13) through Coax (15) then is conducted to Filter (20) who's output is then supplied to the input of Amplifier G1 (19) completing the feedback path (32).

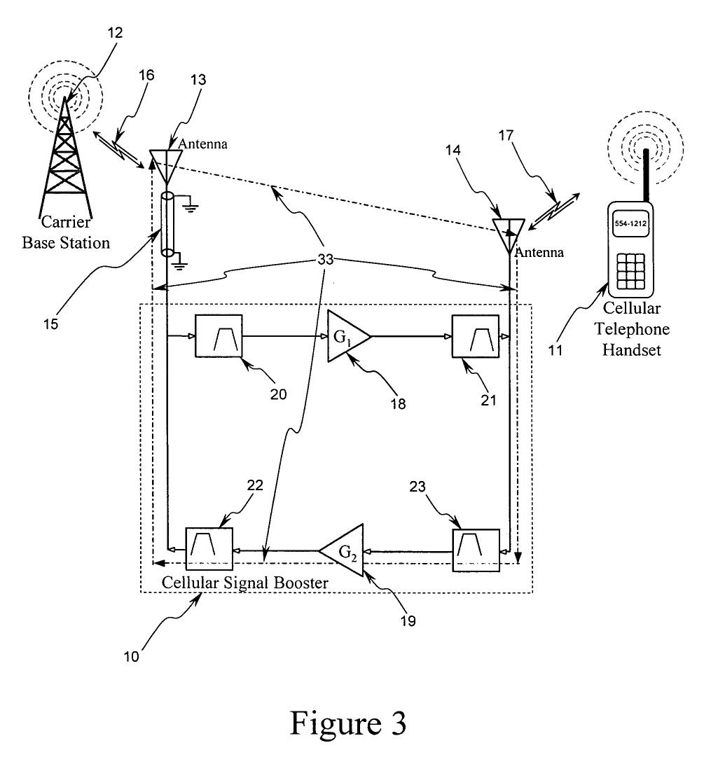

Turning to the drawing in FIG. 3, showing the same drawing as in FIG. 2 but with a signal path (33) highlighted. This drawing shows the second feedback path (33) of reverse direction of potential oscillation for the Amplifier G2 (19) who's output goes through Filter (22) then through the Coax (15) then to the Antenna (13) then radiates through free air to Antenna (14) then is conducted to Filter (23) who's output is then supplied to the input of Amplifier G2 (19) completing the feedback path.

To prevent oscillations the Amplifier's illustrated with their feedback path (32) and (33) in their respective FIGS. 2 and 3. The amplification gain for Amplifier (18) must be less than the sum of the Filter's (20) loss plus the Filter's (21) loss plus the Coax's (15) loss and the Signal Path's (31) loss in free air. Subsequently, to prevent the reverse path (33) from oscillating the Amplifier's (19) amplification gain must be less than the sum of the Filter's (22) loss plus the Filter's (23) loss plus the Coax's (15) loss and the Signal Path's (31) loss in free air.

Mathematically these equations need to be satisfied to prevent oscillation. Where L=Loss and G=Gain, amplification level:
[L₍₂₀₎+L₍₂₁₎+L₍₁₅₎+L₍₃₁₎]≧G₁₍₁₈₎ and [L₍₂₂₎+L₍₂₃₎+L₍₁₅₎+L₍₃₁₎]≧G₂₍₁₉₎

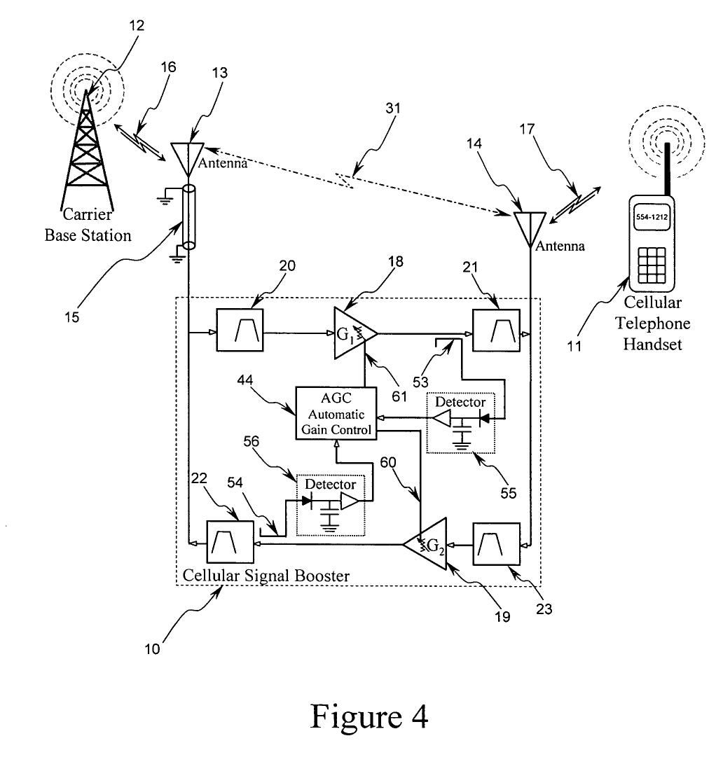

Turning to FIG. 4, showing the same drawing as FIG. 1 but with addition circuitry in The Cellular Signal Booster (10). The Cellular Signal Booster typically has circuitry deployed that automatically adjust the Amplifier's G₁ (18) and Amplifier's G₂ (19) amplification level to prevent oscillation if the amplification levels are equal or higher than the loss described above. The Cellular Signal Booster (10) deploys circuitry that detect the level of signal out of each amplifier through an RF Coupler (53) and Detector (55) and RF Coupler (54) and Detector (56) respectively for each Amplifier (18) and (19). These Couplers and Detectors can sense oscillations from the Antennas (13) and (14) being too close together resulting in a small amount of Signal Path's (31) loss. If oscillation is sensed Detectors (55) and (56) alert the Automatic Gain Control, AGC (44), which subsequently reduces the amplification level, gain, of Amplifier G₁ (18) and Amplifier G₂ (19) through a signal to the amplifiers through (61) and (60) to prevent oscillation.

The AGC (44) adjustment level has a lower amplification limit and cannot reach zero amplification, so if the lower amplification limit of Amplifier G₁ (18) is higher that the losses than the sum of the Filter's (20) loss plus the Filter's (21) loss plus the Coax's (15) loss and the Signal Path's (31) loss in free air, the Cellular Signal Boosters will shut down the Amplifiers (18) and (19). Consequently, in the reverse path if the lower amplification limit of Amplifier G₂ (19) is higher that the losses than the sum of the Filter's (23) loss plus the Filter's (22) loss plus the Coax's (15) loss and the Signal Path's (31) loss in free air, the Cellular Signal Boosters will shut down the Amplifiers (18) and (19). Mathematically, if the amplification level for the two Amplifiers Amplifier G₁ (18) and Amplifier G₂ (19) cannot satisfy these equations, the Cellular Signal Boosters will shut down the Amplifiers (18) and (19). Where L=Loss and G=Gain, amplification level:
[L₍₂₀₎+L₍₂₁₎+L₍₁₅₎+L₍₃₁₎]≧G₁₍₁₈₎ or [L₍₂₂₎+L₍₂₃₎+L₍₁₅₎+L₍₃₁₎]≧G₂₍₁₉₎
When the Amplifier (18) and Amplifier (19) amplification levels are reduced by way of the Detectors (55) and (56) and the AGC Circuitry (44) or if the Amplifiers are shut down, the over all system performance of the Cellular Signal Booster is significantly reduced making little to no improvement in Cellular Coverage in the poor coverage area. This mode of operation of the Cellular Signal Booster is typically caused by a poor installation of the Antenna (13) and Antenna (14).

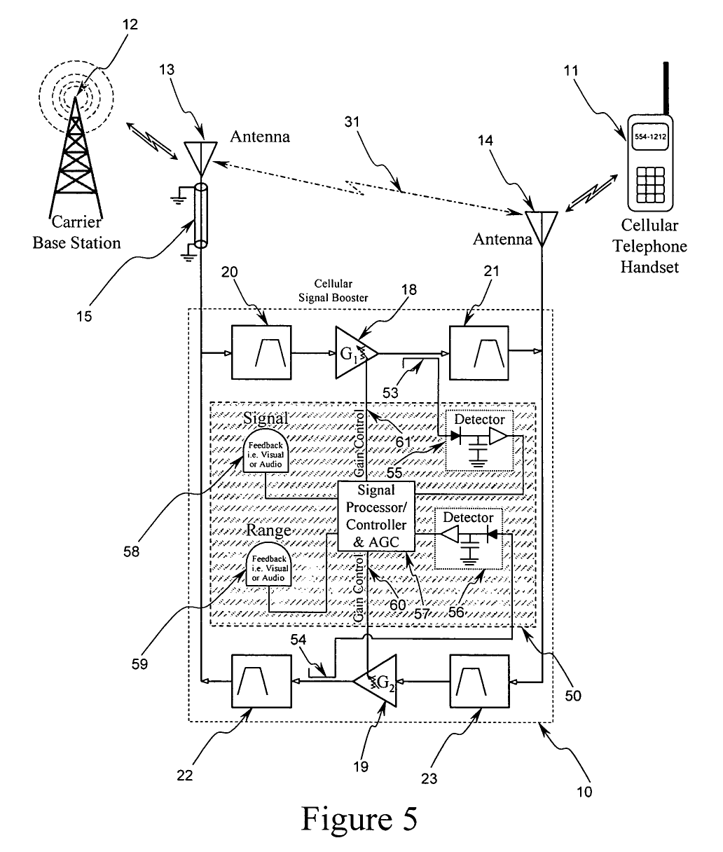

To prevent the Cellular Signal Booster from having poor performance because of a poor installation, an invention was created within a Cellular Signal Booster to significantly aid the consumer in the installation. Turning now to FIG. 5, is another drawing of a Cellular Signal Booster system including the invention to aid the consumer in the installation process for optimum system performance. The invention and its claim A1, resides within box (50). The initial step for proper installation performed by the consumer pertains to installing the Antenna (13) that links to the Carrier Base Station to maximize the quality of signals to and from the Carrier Base Station (12) and the Cellular Signal Booster (10). This initial step is done without the Antenna (14) that link to the Consumer Cellular Telephone Handset (45) being connected. Without this Antenna (14) connected there is no feedback Signal Path (31) that could result in oscillations, which allows the amplification of the signal through Amplifier G₁ (18) to be at its maximum amplification level. The signal from the Carrier Base Station (12) is received by the antenna (13) and sent through the Coax (15) and then passes through the Filter (20). The signal is then amplified by the Amplifier G₁ (18). The output level of signal originating from the Carrier Base Station is detected at the output of the G₁ Amplifier (18) by Coupling Detector (53). This signal is then rectified and filtered by the Detector (55) circuitry. This Direct Current, DC, signal is then supplied to the Signal Processing/Controller & AGC (57) circuitry. This Signal Processing/Controller & AGC (57) mathematically analyzes the input signal level from the Carrier's Base Station into the Cellular Signal Booster. Additionally, this Signal Processing/Controller & AGC (57) circuitry drives the feedback mechanism to the consumer by way of any of their senses such as a visual display or audible signal (58), informing the consumer of the signal strength of the Carrier's Base Station (12) into their Cellular Signal Booster (10). This allows the consumer to adjust the installation position of the Antenna (13) to reach the (peak) highest possible signal level by way of the feedback mechanism to the consumer by way of any of their senses such as a visual display or audible signal (58).

Once the Antenna that links to the Carrier's Base Station (12) is installed by the initial installation step, the Antenna (14) that links to the consumer's Cellular Telephone Handset (11) is connected to the Cellular Signal Booster (10). This second step of installation is to insure that the Antenna's Feedback Path (31) is minimized so the Cellular Signal Booster system can amplify and radiate the strongest signals possible to insure the desired coverage area provides excellent Cellular Telephone call quality. In this second step of installation, the Cellular Signal Booster measures the Antenna's Feedback Path (31) by means of both Detectors Circuitry (53) and (55) for one signal path and Detectors Circuitry (54) and (56) for the other signal path. These two DC signals from the Detectors (55) and (56) are supplied to the Signal Processing/Controller & AGC (57) circuitry where they are mathematically analyzed determining the radiated feedback path loss between the Antenna (13) that links to the Carrier's Base Station (12) and the Antenna (14) that links to the consumer's Cellular Telephone Handset (11). Additional Circuitry in the Signal Processing/Controller & AGC (57) drives the feedback mechanism to the consumer by way of any of their senses such as a visual display or audible signal (59), informing the consumer of the signal level transmitted out of the Cellular Signal Booster. The consumer can now adjust the installation position of the Antenna (14) for the highest possible signal by way of the feedback mechanism to the consumer by way of any of their senses such as a visual display or audible signal (59). The more radiated Feedback Path (31) loss between the Antennas (13) and (14), the higher the amplification level can be out of the amplifiers G₁ (18) and G₂ (19), providing a larger signal being transmitted out of both antennas resulting in larger range in the desired coverage area.

Once the installation is completed the two the feedback mechanisms to the consumer by way of any of their senses such as a visual display or audible signal (58) and (59) will continuously inform the consumer of the current performance notifying them of any system degradation that needs their attention. If a Carrier's Base Station (12) fails, either antenna (13) and (14) fails or are moved from their intended location, an Antenna connection to the Cellular Signal Booster (10) is disrupted or the Cellular Signal Booster fails, the feedback mechanism to the consumer by way of any of their senses such as a visual display or audible signal (58) and (59) will alert the consumer.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed, is:

1. A machine for improving Cellular Coverage comprising: circuitry that mathematically analyzes the input signal level from the Carrier's Base Station into the Cellular Signal Booster; control circuitry that drives a feedback mechanism to the consumer by way of any of their senses such as a visual display or audible signal; to inform the consumer of the input signal level from the Carrier's Base Station into the Cellular Signal Booster for purposes of optimizing the installation.

2. A machine for improving Cellular Coverage comprising: circuitry that mathematically analyzes the radiated feedback path loss between the antenna that links to the Carrier's Base Station and the antenna that links to the consumer's Cellular Telephone Handset and the resultant amplification level of the signals; control circuitry that drives a feedback mechanism to the consumer by way of any of their senses such as a visual display or audible signal; to inform the consumer the signal level transmitted out of the Cellular Signal Booster for purposes of optimizing the installation.

3. A process for improving Cellular Coverage comprising the steps of: improving the installation of the Cellular Signal Booster System using the feedback mechanisms in claim 1 and claim 2 to aid the consumer; a process for optimization of the installation and location of the Antenna that links to the Carrier's Base Station; and a process for optimization of installation and location of the Antenna that links to the consumer's Cellular Telephone Handset.
